(19) United States
(12) Patent Application Publication
(10) Pub. No.: US 2002/0168528 A1
(43) Pub. Date: Nov. 14, 2002

(54) Coated article with polymeric basecoat

(76) Inventors: Patrick B. Jonte, Zionsville, IN (US); James S. Lipe, Carmel, IN (US); Guocun Chen, Broomfield, CO (US)

Correspondence Address: Myron B. Kapustij, Masco Corporation, 21001 Van Born Road, Taylor, MI, 48180, US

(21) Appl. No.: 09/853,331

(22) Filed: May 11, 2001

(51) Int. Cl. B32B 15/08

(52) U.S. Cl. 428/418; 428/472; 428/457; 428/425.8

(57) ABSTRACT

An article is coated with a multi-layer coating having improved chemical and oxidation resistance. The coating comprises a polymeric layer on the article surface, a refractory metal or refractory metal alloy strike layer on the polymeric layer and a protective layer containing a refractory metal oxide or refractory metal alloy oxide.

### FIELD OF THE INVENTION

This invention relates to articles coated with a multilayered protective coating having improved chemical and oxidation resistance.

### BACKGROUND OF THE INVENTION

It is currently the practice with various brass articles such as faucets, faucet escutcheons, door knobs, door handles, door escutcheons and the like to first buff and polish the surface of the article to a high gloss and to then apply a protective organic coating, such as one comprised of acrylics, urethanes, epoxies and the like, onto this polished surface. This system has the drawback that the buffing and polishing operation, particularly if the article is of a complex shape, is labor intensive. Also, the known organic coatings are not always as durable as desired, and are susceptible to attack by acids. It would, therefore, be quite advantageous if brass articles, or indeed other articles, either plastic, ceramic, or metallic, could be provided with a coating which provided the article with a decorative appearance as well as providing wear resistance, abrasion resistance and corrosion resistance. It is known in the art that a multi-layered coating can be applied to an article which provides a decorative appearance as well as providing wear resistance, abrasion resistance and corrosion resistance. This multi-layer coating includes a decorative and protective color layer of a refractory metal nitride such as a zirconium nitride or a titanium nitride. This color layer, when it is zirconium nitride, provides a brass color, and when it is titanium nitride provides a gold color.

U.S. Pat. Nos. 5,922,478; 6,033,790 and 5,654,108, inter alia, describe a coating which provides an article with a decorative color, such as polished brass, and also provides wear resistance, abrasion resistance and corrosion resistance. It would be very advantageous if a coating could be provided which provided substantially the same properties as the coatings containing zirconium nitride or titanium nitride, but was not brass colored or gold colored and provided improved chemical resistance and oxidation resistance. The present invention provides such a coating.

### SUMMARY OF THE INVENTION

The present invention is directed to an article such as a plastic, ceramic or metallic article having a protective multilayer coating deposited on at least a portion of its surface. More particularly, it is directed to an article or substrate, particularly a metallic article such as aluminum, brass or zinc, having deposited on its surface multiple superposed layers of certain specific types of materials. The coating provides corrosion resistance, wear resistance, abrasion resistance and improved chemical resistance and oxidation resistance.

The article first has deposited on its surface a polymeric basecoat layer. On top of the polymeric basecoat layer is then deposited, by vapor deposition such as physical vapor deposition or chemical vapor deposition, one or more vapor deposited layers. More particularly, a first layer deposited directly on the surface of the substrate is comprised of a polymeric material. Over the polymeric layer is a protective layer comprised of a refractory metal oxide.

### BRIEF DESCRIPTION OF THE DRAWINGS

FIG. 1 is a cross-sectional view, not to scale, of a portion of the substrate having the polymeric basecoat layer thereon and the protective layer on the polymeric layer;

FIG. 2 is a view similar to FIG. 1 except that a refractory metal or refractory metal alloy strike layer is intermediate the polymeric layer and the protective layer; and

FIG. 3 is a view similar to FIG. 2 except that a refractory metal oxynitride or refractory metal alloy oxynitride is on said protective layer.

### DESCRIPTION OF THE PREFERRED EMBODIMENTS

The article or substrate 12 can be comprised of any material onto which a plated layer can be applied, such as plastic, e.g., ABS, polyolefin, polyvinylchloride, and phenolformaldehyde, ceramic, metal or metal alloy. In one embodiment it is comprised of a metal or metallic alloy such as copper, steel, brass, zinc, aluminum, nickel alloys and the like.

In the instant invention, as illustrated in FIGS. 1-3, a polymeric or resinous basecoat layer 13 is applied onto the surface of the article. Over the polymer layer 13 is applied a refractory metal oxide or refractory metal alloy oxide protective layer 32 by vapor deposition. The polymeric layer serves, inter alia, as a basecoat which smoothes and covers any scratches or imperfections in the surface of the article. The polymeric basecoat layer 13 may be comprised of both thermoplastic and thermoset polymeric or resinous material. These polymeric or resinous materials include the well known, conventional and commercially available polycarbonates, epoxy urethanes, polyacrylates, polymethacrylates, nylons, polyesters, polypropylenes, polyepoxies, alkyds and styrene containing polymers such as polystyrene, styrene-acrylonitrile (SAN), styrene-butadiene, acrylonitrile-butadiene-styrene (ABS), and blends and copolymers thereof.

The polycarbonates are described in U.S. Pat. Nos. 4,579,910 and 4,513,037, both of which are incorporated herein by reference.

Nylons are polyamides which can be prepared by the reaction of diamines with dicarboxylic acids. The diamines and dicarboxylic acids which are generally utilized in preparing nylons generally contain from two to about 12 carbon atoms. Nylons can also be prepared by additional polymerization. They are described in “Polyamide Resins”, D. E. Floyd, Reinhold Publishing Corp., New York, 1958, which is incorporated herein by reference.

The polyepoxies are disclosed in “Epoxy Resins”, by H. Lee and K. Nevill, McGraw-Hill, New York, 1957, and in U.S. Pat. Nos. 2,633,458; 4,988,572; 4,680,076; 4,933,429 and 4,999,388, all of which are incorporated herein by reference.

The polyesters are polycondensation products of an aromatic dicarboxylic acid and dihydric alcohol. The aromic dicarboxylic acids include terephthalic acid, isophthalic acid, 4,4′-diphenyl-dicarboxylic acid, 2,6-naphthalenedicarboxylic acid, and the like. Dihydric alcohols include the lower alkane diols with from two to about 10 carbon atoms such as, for example, ethylene glycol, propylene glycol, cyclohexanedimethanol, and the like. Some illustrative non-limiting examples of polyesters include polyethylene terephthalate, polybutylene terephthalate, polyethylene isophthalate, and poly(1,4-cyclohexanedimethylene terephthalate). They are disclosed in U.S. Pat. Nos. 1,465,319; 2,901,466 and 3,047,539, all of which are incorporated herein by reference.

The polyacrylates and polymethacrylates are polymers or resins resulting from the polymerization of one or more acrylates such as, for example, methyl acrylate, ethyl acrylate, butyl acrylate, 2-ethylhexyl acrylate, etc., as well as the methacrylates such as, for instance, methyl methacrylate, ethyl methacrylate, butyl methacrylate, hexyl methacrylate, etc. Copolymers of the above acrylate and methacrylate monomers are also included within the term “polyacrylates” or “polymethacrylates” as it appears therein. The polymerization of the monomeric acrylates and methacrylates to provide the polyacrylate resins useful in the practice of the invention may be accomplished by any of the well known polymerization techniques.

The styrene-acrylonitrile and acrylonitrile-butadiene-styrene resins and their preparation are disclosed, inter alia, in U.S. Pat. Nos. 2,769,804; 2,989,517; 2,739,142; 3,991,136 and 4,387,179, all of which are incorporated herein by reference.

The alkyd resins are disclosed in “Alkyd Resin Technology”, Patton, Interscience Publishers, NY, N.Y., 1962, and in U.S. Pat. Nos. 3,102,866; 3,228,787 and 4,511,692, all of which are incorporated herein by reference.

The epoxy urethanes and their preparation are disclosed, inter alia, in U.S. Pat. Nos. 3,963,663; 4,705,841; 4,035,274; 4,052,280; 4,066,523; 4,159,233; 4,163,809; 4,229,335 and 3,970,535, all of which are incorporated by reference. Particularly useful epoxy urethanes are those that are electrocoated onto the article. Such electrodepositable epoxy urethanes are described in the aforementioned U.S. Pat. Nos. 3,963,663; 4,066,523; 4,159,233; 4,035,274 and 4,070,258.

These polymeric materials may optionally contain the conventional and well known fillers such as mica, talc and glass fibers.

The polymeric basecoat layer 13 may be applied onto the surface of the substrate to, inter alia, cover any scratches or imperfections in the surface of the article and provide a smooth and even surface for the deposition of the succeeding layers such as the vapor deposited layers.

The polymeric basecoat layer 13 has a thickness at least effective to level out the surface of the article or substrate. Generally, this thickness is at least about 0.12 μm, preferably at least about 2.5 μm, and more preferably at least about 5 μm. The upper thickness range should not exceed about 250 μm.

In some instances, depending on the substrate material and the type of polymeric basecoat, the polymeric basecoat does not adhere sufficiently to the substrate. In such a situation a primer layer is deposited on the substrate to improve the adhesion of the polymeric basecoat to the substrate. The primer layer can be comprised, inter alia, of halogenated polyolefins. The halogenated polyolefins are conventional and well known polymers that are generally commercially available. The preferred halogenated polyolefins are the chlorinated and brominated polyolefins, with the chlorinated polyolefins being more preferred. The halogenated, particularly chlorinated, polyolefins along with methods for their preparation are disclosed, inter alia, in U.S. Pat. Nos. 5,319,032; 5,840,783; 5,385,979; 5,198,485; 5,863,646; 5,489,650 and 4,273,894, all of which are incorporated herein by reference.

The thickness of the primer layer is a thickness effective to improve the adhesion of the polymeric basecoat layer to the substrate. Generally this thickness is at lest about 0.25 μm. The upper thickness is not critical and generally is controlled by secondary considerations such as cost and appearance. Generally an upper thickness of about 125 μm should not be exceeded.

As illustrated in FIG. 1, over the polymeric layer is deposited, by vapor deposition such as physical vapor deposition or chemical vapor deposition, a protective and decorative color layer 32 comprised of a refractory metal oxide or refractory metal alloy oxide.

The refractory metal comprising the refractory metal oxide is zirconium, titanium, hafnium and the like, preferably zirconium, titanium or hafnium. A refractory metal alloy such as zirconium-titanium alloy, zirconium-hafnium alloy, titanium-hafnium alloy, and the like may be used to form the oxide. Thus, for example, the oxide may include a zirconium-titanium alloy oxide.

The thickness of this protective layer 32 is a thickness which is at least effective to provide abrasion resistance, scratch resistance, wear resistance, and improved chemical and oxidation resistance. Generally, this thickness is at least about 1,000 Å, preferably at least about 1,500 Å, and more preferably at least about 2,500 Å. The upper thickness range is generally not critical and is dependent upon secondary considerations such as cost. Generally a thickness of about 0.75 μm, preferably about 0.5 μm should not be exceeded.

One method of depositing layer 32 is by physical vapor deposition utilizing reactive sputtering or reactive cathodic arc evaporation. Reactive cathodic arc evaporation and reactive sputtering are generally similar to ordinary sputtering and cathodic arc evaporation except that a reactive gas is introduced into the chamber which reacts with the dislodged target material. Thus, in the instant case where layer 32 is comprised of zirconium oxide, the cathode is comprised of zirconium, and oxygen is the reactive gas introduced into the chamber.

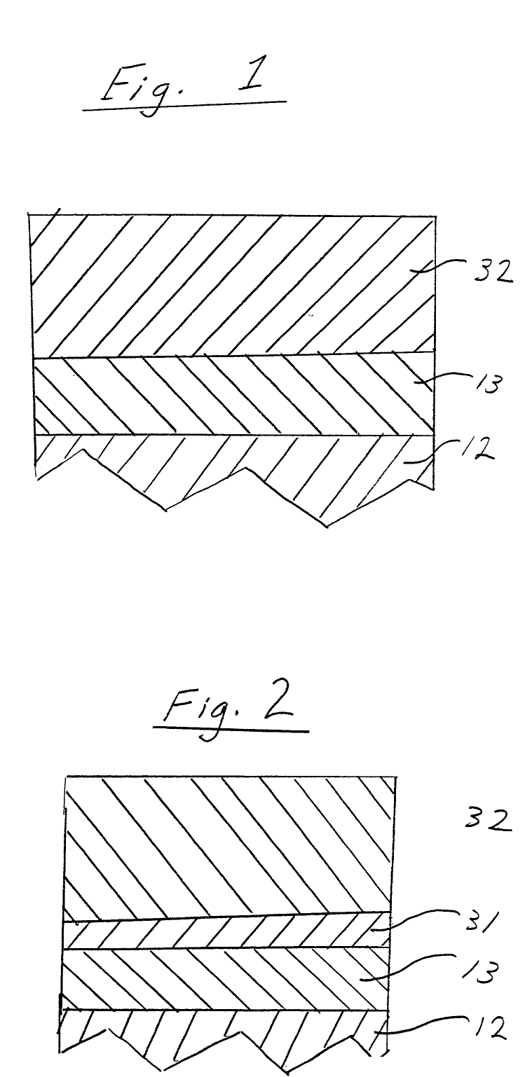

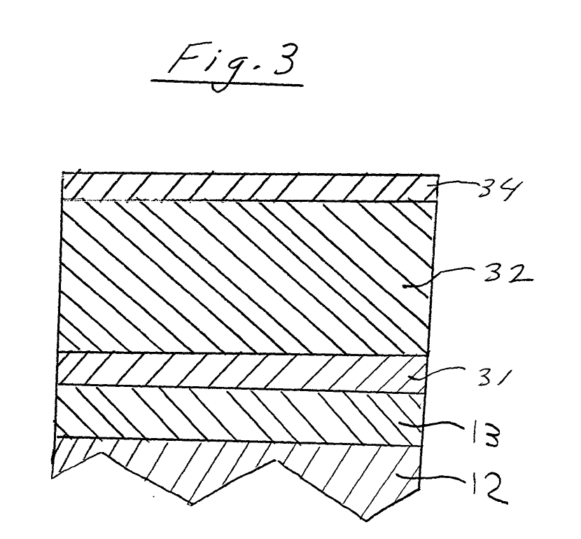

The coating may contain other vapor deposited layers in addition to protective layer 32. As illustrated in FIGS. 2 and 3, a refractory metal or refractory metal alloy strike layer 31 is disposed intermediate the protective layer 32 and the polymeric layer. Layer 31 has a thickness which is generally at least effective for layer 31 to function as a strike layer. Generally, this thickness is at least about 60 Å, preferably at lest about 120 Å, and more preferably at least about 250 Å. The upper thickness range is not critical and is generally dependent upon considerations such as cost. Generally, however, layer 31 should not be thicker than about 1.2 μm, preferably about 0.5 μm, and more preferably about 0.25 μ.

The refractory metal or refractory metal alloy layer 31 is deposited by conventional and well known vapor deposition techniques including physical vapor deposition techniques such as cathodic arc evaporation (CAE) or sputtering. Sputtering techniques and equipment are disclosed, inter alia, in J. Vossen and W. Kern “Thin Film Processes II”, Academic Press, 1991; R. Boxman et al, “Handbook of Vacuum Arc science and Technology”, Noyes Pub., 1995; and U.S. Pat. Nos. 4,162,954 and 4,591,418, all of which are incorporated herein by reference.

Briefly, in the sputtering deposition process a refractory metal (such as titanium or zirconium) target, which is the cathode, and the substrate are placed in a vacuum chamber. The air in the chamber is evacuated to produce vacuum conditions in the chamber. An inert gas, such as Argon, is introduced into the chamber. The gas particles are ionized and are accelerated to the target to dislodge titanium or zirconium atoms. The dislodged target material is then typically deposited as a coating film on the substrate.

In cathodic arc evaporation, an electric arc of typically several hundred amperes is struck on the surface of a metal cathode such as zirconium or titanium. The arc vaporizes the cathode material, which then condenses on the substrates forming a coating.

In a preferred embodiment of the present invention the refractory metal is comprised of titanium or zirconium, preferably zirconium, and the refractory metal alloy is comprised of zirconium-titanium alloy.

As illustrated in FIG. 3, over protective layer 32 may be a thin layer 34 comprised of the reaction products of a refractory metal or refractory metal alloy, oxygen and nitrogen. The reaction products of refractory metal or refractory metal alloy, oxygen and nitrogen are generally comprised of the refractory metal oxide or refractory metal alloy oxide, refractory metal nitride or refractory metal alloy nitride and refractory metal oxy-nitride or refractory metal alloy oxy-nitride. Thus, for example, the reaction products of zirconium, oxygen and nitrogen comprise zirconium oxide, zirconium nitride and zirconium oxynitride. These refractory metal oxides and refractory metal nitrides including zirconium oxide and zirconium nitride alloys and their preparation and deposition are conventional and well known, and are disclosed, inter alia, in U.S. Pat. No. 5,367,285, the disclosure of which is incorporated herein by reference.

Layer 34 is effective in providing additional improved oxidation resistance and additional improved chemical, such as acid or base, resistance to the coating. Layer 34 generally has a thickness at least effective to provide additional improved oxidation and chemical resistance. Generally this thickness is at least about 10 Å, preferably at least about 25 Å, and more preferably at least about 40 Å. Generally layer 34 should not be thicker than about 0.10 μm, preferably about 250 Å, and more preferably about 100 Å.

In order that the invention may be more readily understood, the following example is provided. The example is illustrative and does not limit the invention thereto.

### EXAMPLE

Brass faucets are placed in a conventional soak cleaner bath containing the standard and well known soaps, detergents, defloculants and the like which is maintained at a pH of 8.9-9.2 and a temperature of 180-200° F. for about 10 minutes.

The faucets are immersed into a cathodic electrodeposition bath containing reaction products of a polyamine and epoxy-urethane available from Lilly Industries under the trade name Micro Finish. The resin is supplied by Lilly Industries at approximately 25-40% solids and is diluted with de-ionized water to a solids range between 3% and 20%. The polymer basecoat is deposited on the cathodic substrate (faucets) by applying between about 50 and 400 D.C. volts for about three minutes with the electrodeposition bath temperature between about 75° F. and 120° F. The polymer coated faucets are removed from the electrodeposition bath and rinsed with water. The polymer coated faucets are placed in an oven and the polymer is cured at about 300° F. for 18 minutes followed by another cure for 18 minutes at about 500° F. to about 560° F. The resulting cured polymeric basecoat has a thickness of about 0.5 mil.

The polymer coated faucets are placed in a cathodic arc evaporation plating vessel. The vessel is generally a cylindrical enclosure containing a vacuum chamber which is adapted to be evacuated by means of pumps. A source of argon gas is connected to the chamber by an adjustable valve for varying the rate of flow of argon into the chamber. In addition, a source of oxygen gas is connected to the chamber by an adjustable valve for varying the rate of flow of oxygen into the chamber.

A cylindrical cathode is mounted in the center of the chamber and connected to negative outputs of a variable D.C. power supply. The positive side of the power supply is connected to the chamber wall. The cathode material comprises zirconium.

The polymer coated faucets are mounted on spindles, 16 of which are mounted on a ring around the outside of the cathode. The entire ring rotates around the cathode while each spindle also rotates around its own axis, resulting in a so-called planetary motion which provides uniform exposure to the cathode for the multiple faucets mounted around each spindle. The ring typically rotates at several rpm, while each spindle makes several revolutions per ring revolution. The spindles are electrically isolated from the chamber and provided with rotatable contacts so that a bias voltage may be applied to the substrates during coating.

The vacuum chamber is evacuated to a pressure of 5×10⁻³ millibar and heated to about 100° C.

The coated faucets are then subjected to a high-bias arc plasma cleaning in which a (negative) bias voltage of about 500 volts is applied to the coated faucets while an arc of approximately 500 amperes is struck and sustained on the cathode. The duration of the cleaning is approximately five minutes.

Argon gas is introduced at a rate sufficient to maintain a pressure of about 1 to 5 millitorr. A layer of zirconium having an average thickness of about 0.1 microns is deposited on the polymeric basecoated faucets during a three minute period. The cathodic arc deposition process comprises applying D.C. power to the cathode to achieve a current flow of about 460 amperes, introducing argon gas into the vessel to maintain the pressure in the vessel at about 2 millitorr and rotating the faucets in a planetary fashion described above.

After the zirconium layer is deposited a protective layer comprised of zirconium oxide is deposited on the zirconium layer. The flow rate of argon gas is continued at about 250 sccm and oxygen is introduced at a flow rate of about 375 sccm, while the arc discharge continues at approximately 460 amperes. The flow of argon and oxygen is continued for about 40 minutes. The thickness of the protective layer is about 3500-4500 Å. After this protective layer is deposited, the arc is extinguished, the vacuum chamber is vented, and the coated articles removed.

While certain embodiments of the invention have been described for purposes of illustration, it is to be understood that there may be other various embodiments and modifications within the general scope of the invention.

We claim:

1. An article having on at least a portion of its surface a multi-layer coating comprising:
a polymeric layer;
protective layer comprised of a refractory metal oxide or refractory metal alloy oxide.

2. The article of claim 1 wherein a strike layer comprised of a refractory metal or refractory metal alloy is intermediate said polymeric layer and said protective layer.

3. The article of claim 2 wherein a layer comprised of the reaction products of a refractory metal or refractory metal alloy, oxygen and nitrogen is on said protective layer.

4. The article of claim 1 wherein a layer comprised of the reaction products of a refractory metal or a refractory metal alloy, oxygen and nitrogen is on said protective layer.

5. The article of claim 1 wherein said polymeric layer is comprised of an epoxy urethane.

6. An article having on at least a portion of its surface a multi-layer coating having improved chemical and oxidation resistance comprising:
a polymeric layer on the surface of said article; and
a protective layer comprised of a refractory metal oxide or refractory metal alloy oxide.

7. The article of claim 6 wherein a layer comprised of refractory metal or refractory metal alloy is intermediate said polymeric layer and said protective layer.

8. The article of claim 7 wherein said polymeric layer is comprised of epoxy urethane.

9. The article of claim 6 wherein a layer comprised of the reaction products of refractory metal or refractory metal alloy, oxygen and nitrogen is on said protective layer.
